(19) United States
(12) Patent Application Publication
(10) Pub. No.: US 2010/0316428 A1
(43) Pub. Date: Dec. 16, 2010

(54) PENCIL

(75) Inventor: Markus Hillemann, Kranzberg (DE)

Correspondence Address: HAMRE, SCHUMANN, MUELLER & LARSON, P.C., P.O. BOX 2902, MINNEAPOLIS, MN, 55402-0902, US

(73) Assignee: JOHANN FROESCHEIS LYRA-BLEISTIFT- FABRIK GMBH & CO. KG, Nurnberg (DE)

(21) Appl. No.: 12/867,440

(22) PCT Filed: Feb. 13, 2009
(86) PCT No.: PCT/EP09/01045

§ 371 Date: Aug. 12, 2010

(30) Foreign Application Priority Data
Feb. 14, 2008 (DE) 20 2008 002 102.2

(51) Int. Cl. B43K 19/00

(52) U.S. Cl. 401/49

(57) ABSTRACT

The invention relates to a pencil, such as a writing, drawing, or sketching pen, having a pencil lead (2) and a wood body (3) surrounding the pencil lead (2), wherein the pencil (1) has a substantially three-surface shape extending across the pencil length, comprising three gripping surfaces (4, 5, 6), wherein gripping depressions (7) disposed behind one another are provided on at least two gripping surfaces (4, 5, 6) across at least part of the pencil length.

The invention concerns a pencil, for example, a writing, sketching or drawing pencil, with a lead and a wooden body enclosing the lead, the pencil having an essentially three-surface shape extending over the pencil length with three gripping surfaces.

Writing, sketching or drawing pencils ordinarily have a lead and a wooden body enclosing the lead. The pencils in cross-section are circular, hexagonal or octagonal or even triangular. Pencils are known that have an essentially three-surface shape with three gripping surfaces extending over the pencil length. The three gripping surfaces serve to support the three fingers enclosing the pencil, i.e., thumb, index finger and middle finger. Such three-surface pencils can be securely held during drawing or sketching.

The task of the present invention is to devise a generic pencil, with which ergonomics and handling are improved.

This task is solved by the overall instructions of claim 1. Advantageous modifications of the invention are apparent from dependent claims 2-11.

According to the invention, gripping depressions arranged one behind the other are provided on at least two gripping surfaces of the essentially three-surface pencil over at least part of the pencil length. By support in the gripping depressions, the user can securely hold the pencil advantageously. Since the depressions extend over at least part of the pencil length, they are also present when the pencil is shortened because of sharpening. In particular, the gripping depressions are situated on all gripping surfaces, so that the corresponding support is made possible for all fingers enclosing the pencil. The gripping depressions also have the additional effect that they serve as a recognition design element.

The gripping depressions on a gripping surface can be arranged at constant spacing from each other. This ensures that even after sharpening and therefore shortening of the pencil, corresponding and identically positioned gripping depressions are always available.

The gripping depressions of the different gripping surfaces, with particular advantage, can be offset relative to each other in the longitudinal direction of the pencil. The gripping depressions, on this account, are ideally adapted to the also offset position of the individual fingers. The gripping depressions, in particular, can be arranged in a spiral around the outer surface of the pencil, so that the corresponding offset of the gripping depressions continuously repeats. By rotating the pencil, the gripping depression position appropriate for the user can also be adjusted.

It is ergonomically advantageous for the gripping position of the fingers if the gripping depressions of the different gripping surfaces are offset relative to each other by a third of the distance between centers of the gripping depressions.

The gripping depressions can be designed as essentially circular. Relatively large support surfaces for the fingers are created on this account, in which the fingers can be advantageously supported, because of the round configuration.

However, it is also possible that at least some of the gripping depressions are designed essentially elliptical or oval. Elliptical gripping depressions can be arranged in or across or oblique to the longitudinal axis of the pencil. Depending on the requirement, it is possible that the elliptical or oval gripping depressions are positioned differently relative to the longitudinal axis of the pencil.

The gripping depressions can be expediently configured, so that they have a depth from 1 mm to 2 mm in their deepest area. The desired support effect is already achieved by this.

The width of the gripping depressions can advantageously be at least as large as half the width of the corresponding gripping surface, so that as much surface as possible is utilized for the gripping depressions. For example, the gripping depressions can have diameters of 6 mm to 7 mm, so that good support of the fingers is possible. The width of the gripping surfaces in this case can be, for example, 9 mm to 10 mm.

Rounded edge areas can be provided between the gripping surfaces, so that the pencil can be held in a user-friendly manner.

With particular advantage the gripping surfaces can be made convex. A particularly ergonomically shaped pencil is made available with this outwardly curved bulging. In combination with the gripping depressions, a particularly user-friendly overall ergonomics is obtained. The convex gripping surfaces also have the advantage that the round gripping depressions can be introduced by means of a cylindrical milling cutter. However, it is also possible to use a spherical milling head and to produce gripping depressions in the form of spherical caps with it.

The invention is further explained by means of a preferred practical example depicted in the drawing figures. The figures show:

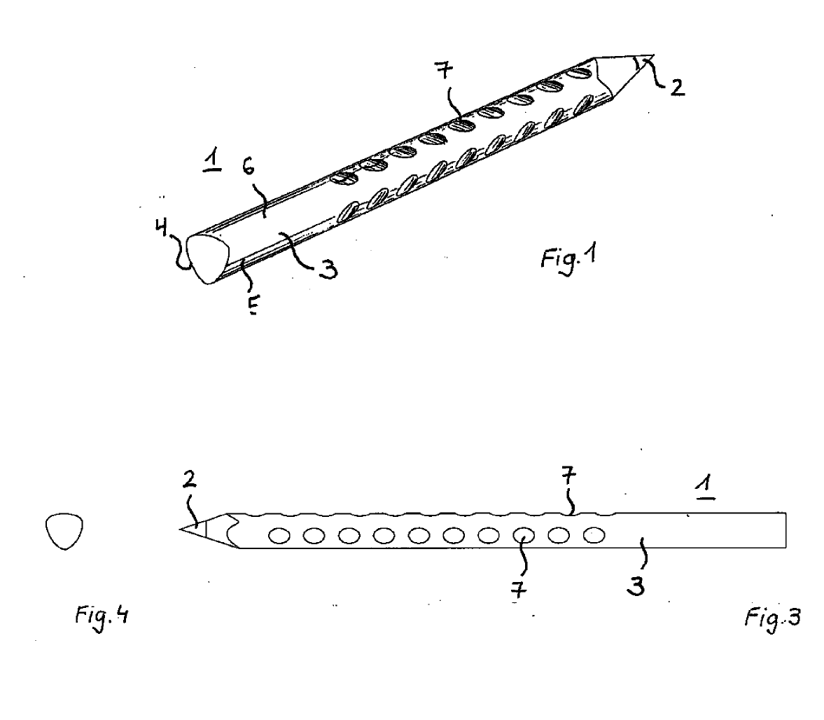

FIG. 1 a perspective view of the pencil according to the invention,

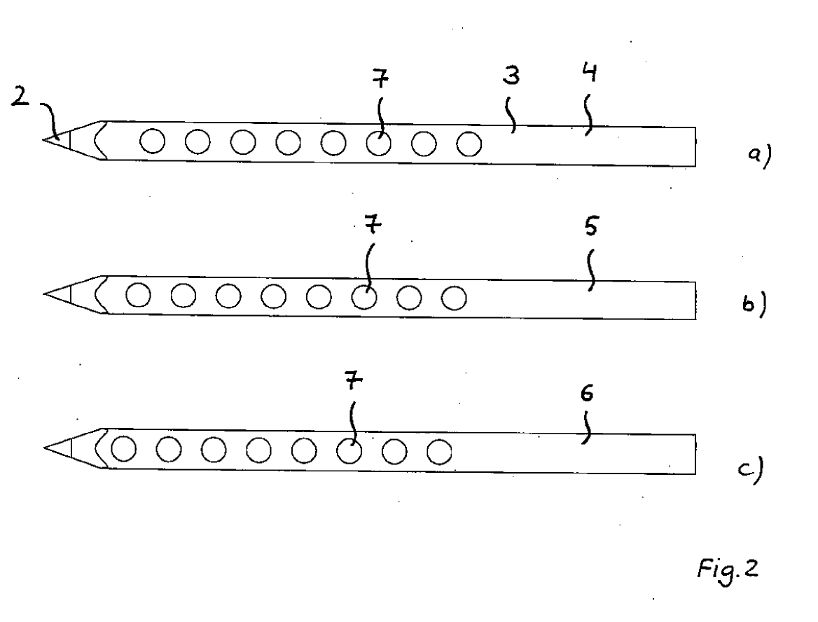

FIG. 2 a) to c) side views of the pencil on three different gripping surfaces,

FIG. 3 another side view of the pencil, and

FIG. 4 a rear view of the pencil.

Reference number 1 denotes the pencil in its entirety. Pencil 1 is a writing, drawing or sketching pencil. Pencil 1 has a lead 2, which is enclosed by a wooden body 3. Pencil 1 also has an essentially three-surface shape extending over the pencil length with three gripping surfaces 4, 5, 6. Over most of the pencil length (from the front to beyond the middle), gripping depressions 7, arranged one behind the other, are provided on the gripping surfaces 4, 5, 6. By means of gripping depressions 7, the pencil 1 can be properly and securely held during sketching and drawing, in that the fingers, especially the thumb, index finger and middle finger can be supported in the gripping depressions 7. The also optically conspicuous gripping depressions 7 serve as a recognition feature as well. In particular, the diameter of the gripping depressions 7 corresponds to roughly the dialneter of the lead 2, which is also advantageous in an optical respect, owing to a certain repetition effect of the shaping elements.

The gripping depressions 7 are offset on the different gripping surfaces 4, 5 6 in the longitudinal direction of the pencil 1. Since the fingers during the gripping of a pencil are also positioned offset, optimal holding of the pencil 1 is made possible.

The gripping depressions 7 are arranged in a spiral around the outer surface, i.e., wooden body 3, which is an optical advantage. This arrangement of gripping depressions 7, however, also has the advantage that even during shortening of the pencil length, i.e., during sharpening, the same arrangement of gripping depressions 7 is always present. By rotating the pencil 1, the exact gripping depressions 7 correct for use of the pencil 1 can also be selected.

As follows, especially from FIG. 2, the gripping depressions 7 of the different gripping surfaces 4, 5, 6 are offset relative to each other by one-third of the distance between centers of the gripping depressions 7. This position of the gripping depressions 7 is particularly advantageous for the gripping position of the fingers.

The gripping depressions 7 are designed essentially circular, so that the fingers can be supported well and comfortably in them. The gripping depressions 7 can also have other shapes, like elliptical or oval, which, however, are not shown in the drawing figures.

The gripping depressions 7 in their deepest area have a depth from 1 mm to 2 mm (see FIG. 3). The width of the gripping depressions 7 is greater than half the width of the corresponding gipping surfaces 4, 5, 6. Relatively large-surface gripping depressions 7 are therefore made available, which serve as a particularly good support for the fingers.

Rounded edge areas 8 are provided between gripping surfaces 4, 5, 6 (see FIGS. 1 and 4). These rounded edge areas 8 are particularly advantageous for an ergonomically shaped pencil. The gripping surfaces 4, 5, 6 are also convex, i.e., curved outward. The rear view according to FIG. 4, in particular, shows the external ergonomic shape of the pencil 1. The outwardly bulging gripping surfaces 4, 5, 6 are particularly suited for supporting the fingers and for good holding of the pencil. In the outwardly arched gripping surfaces 4, 5, 6, the round gripping depressions 7 can be introduced simply by means of a cylindrical milling head (see FIG. 3). The three-surface shape of the pencil 1 with the convex gripping surfaces 4, 5, 6, as well as the gripping depressions 7, produces a particularly advantageous overall ergonomics. However, the external appearance of the pencil 1 is also impressive and unmistakable.

### LIST OF REFERENCE NUMBERS

1 Pencil
2 Lead
3 Wooden body
4 Gripping surface
5 Gripping surface
6 Gripping surface
7 Gripping depression
8 Edge area

1. Pencil, for example, writing, sketching or drawing pencil, with a lead (2) and a wooden body (3) enclosing the lead (2), the pencil (1) having an essentially three-surface shape with three gripping surfaces (4, 5, 6) extending over the pencil length,
wherein
gripping depressions (7), arranged one behind the other, are provided over at least part of the pencil length on at least three gripping surfaces (4, 5, 6), the gripping depressions (7) are essentially circular and the gripping depressions (7) of the different gripping surfaces (4, 5, 6) are offset relative to each other by a third of the distance between centers of the gripping depressions (7).

2. Pencil according to claim 1,
wherein
the gripping depressions (7) are arranged on a gripping surface (4, 5, 6) at constant spacing from each other.

3. Pencil according to claim 1,
wherein
the gripping depressions (7) are arranged in a spiral around the outer surface.

4. Pencil according to claim 1,
wherein
the gripping depressions (7) have a depth from 1 mm to 2 mm in their deepest area.

5. Pencil according to claim 1,
wherein
the width of the gripping depressions (7) is at least as large as half the width of the gripping surfaces (4, 5, 6).

6. Pencil according to claim 1,
wherein
rounded edge areas (8) are provided between the gripping surfaces (4, 5, 6).

7. Pencil according to claim 1,
wherein
the gripping surfaces (4, 5, 6) are convex.

8. Pencil according to claim 7,
wherein
the elliptical gripping depressions (7) are arranged in or across or oblique to the longitudinal axis of the pencil (1).

9. Pencil according to claim 1,
wherein
the gripping depressions (7) have a depth from 1 mm to 2 mm in their deepest area.

10. Pencil according to claim 1,
wherein
the width of the gripping depression (7) is at least as large as half the width of the gripping surfaces (4, 5, 6).

11. Pencil according to claim 1,
wherein
rounded edge areas (8) are provided between the gripping surfaces (4, 5, 6).

12. Pencil according to claim 1,
wherein
the gripping surfaces (4, 5, 6) are designed convex.
